(19) United States
(12) Patent Application Publication
(10) Pub. No.: US 2010/0001683 A1
(43) Pub. Date: Jan. 7, 2010

(54) CHARGING APPARATUS, PORTABLE ELECTRONIC DEVICE USING THE APPARATUS, AND CHARGING METHOD THEREOF

(75) Inventor: YI-YANG HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: Chi Mei Communication Systems, Inc., Tu-Cheng City (TW)

(21) Appl. No.: 12/471,547

(22) Filed: May 26, 2009

(30) Foreign Application Priority Data
Jul. 3, 2008 (CN) 200810302516.6

(51) Int. Cl. H02J 7/00

(52) U.S. Cl. 320/108

(57) ABSTRACT

A charging apparatus includes an antenna, a receiver, and a battery. The battery is charged by a harvester, which converts wireless energy sent by antenna to direct current and charges the battery. The harvester includes a sensor coil, a rectifier and voltage regulating filter. The wireless energy is converted by the sensor coil to alternating current (AC). The rectifier is electrically connected to the sensor coil for converting AC to direct current (DC). The voltage regulating filter is electrically connected to the rectifier to regulate DC. The battery can be charged by the wireless charge apparatus.

### BACKGROUND

1. Technical Field

The disclosure relates to a charging apparatus, and particularly to a charging apparatus having an energy harvester which receives wireless energy and converts the energy into current.

2. Description of Related Art

Portable electronic devices in common and widespread use including cell phones, cameras, PDAs, music players, notebooks, and many others. Rechargeable batteries play a critical role in use of these devices. Many portable electronic devices can directly recharge their batteries themselves. However, rechargeable batteries are not always reliable. Problems range from batteries losing power from inactivity to batteries losing power at inopportune times from continued use. Most of these systems require a hardwired connection or physical contact with electrodes to recharge the battery. Such physical contact with electrodes inherently creates wear on contact elements associated with the numerous times the device is recharged.

Therefore, there is room for improvement within the art.

### BRIEF DESCRIPTION OF THE DRAWINGS

Many aspects of the present charging apparatus can be better understood with reference to the following drawings. The components in the drawings are not necessarily drawn to scale, the emphasis instead being placed upon clearly illustrating the principles of the present charging apparatus.

FIG. 1 is a schematic view of a charging apparatus in accordance with an embodiment.

FIG. 2 is a schematic view of a sensor coil in the charging apparatus of FIG. 1, wherein the sensor coil is square.

FIG. 3 is a schematic view of a sensor coil in the charging apparatus of FIG. 1, wherein the sensor coil is a rounded square.

FIG. 4 is a schematic view of a portable electronic device having a charging apparatus, such as that in FIG. 1, wherein an antenna is an external antenna.

FIG. 5 is a schematic view of the portable electronic device of FIG. 1, wherein the antenna is an internal antenna.

Corresponding reference characters indicate corresponding parts throughout the several views. The exemplifications set out herein illustrate at least one embodiment of the present charging apparatus, in one form, and such exemplifications are not to be construed as limiting the scope of the invention in any manner.

### DETAILED DESCRIPTION

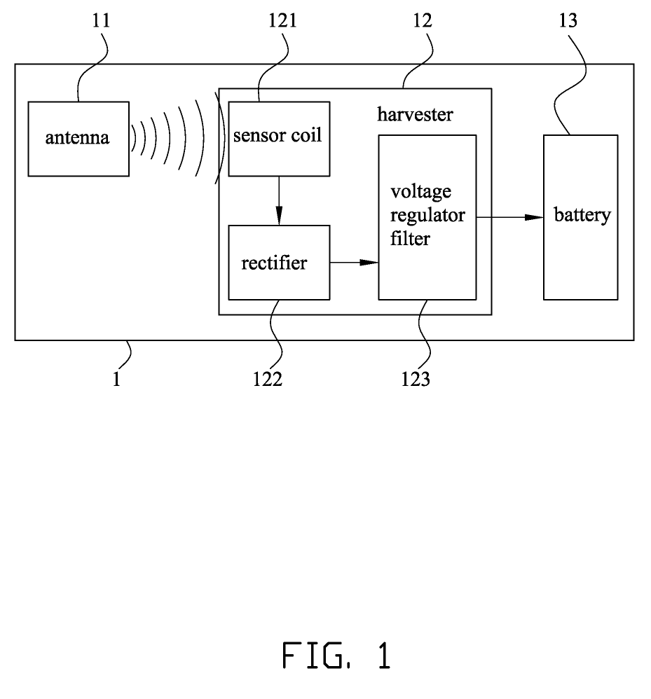

Referring to FIG. 1, a charging apparatus 1 includes an antenna 11, a harvester 12, and a battery 13 connected to the harvester 12. The harvester 12 receives wireless energy from the antenna 11 and converts the wireless energy into current for charging battery 13.

The harvester 12 includes a sensor coil 121, a rectifier 122 electrically connected to the sensor coil 121, and a voltage regulating filter 123 electrically connected to the rectifier 122. The sensor coil 121 receives wireless energy from the antenna 11 by electromagnetic induction and transforms the wireless energy to alternating current (AC). The rectifier transforms the AC signal into direct current (DC). The voltage regulating filter 123 regulates the voltage of the DC signal and then outputs the DC signal to the battery. The battery is charged by the received DC signal. The voltage regulating filter 123 composed of a plurality of capacitors (not shown) can modify the voltage waveform of the DC signal and generate a constant current to the battery.

The sensor coil 121 is an electrically conductive material. In one embodiment, the sensor coil 121 and antenna 11 are composed of the same material, having the same transmission and reception frequency. The matched frequencies of the sensor coil 121 and antenna 11 promote the efficiency of electromagnetic induction.

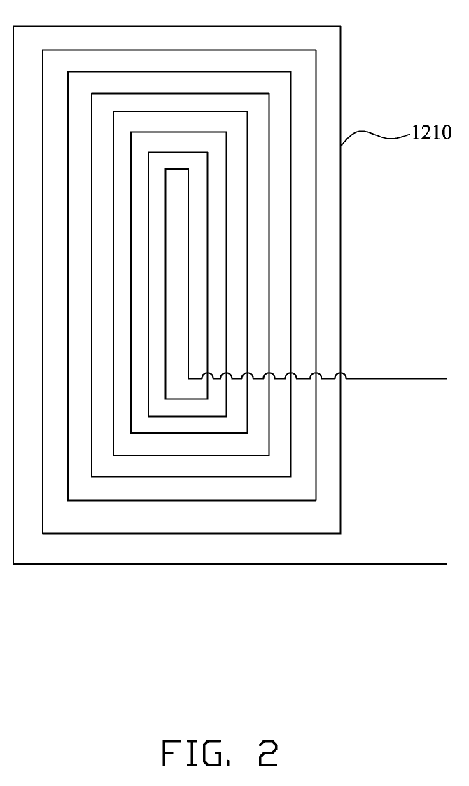

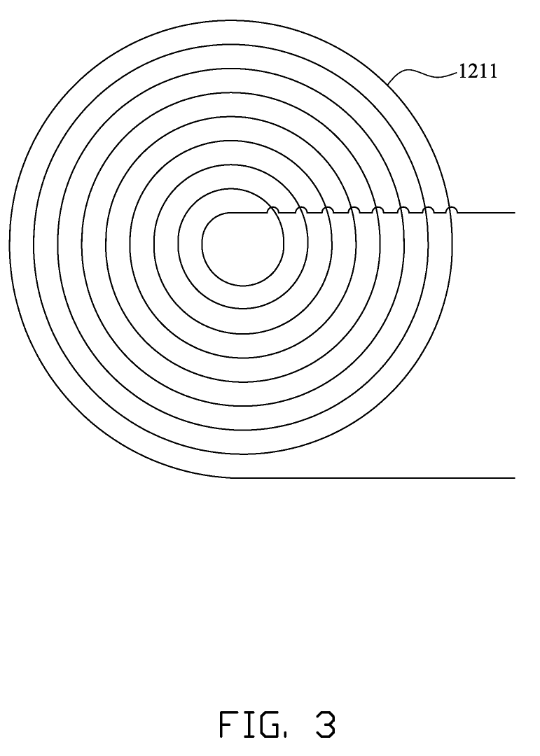

The sensor coil 121 can be wound in a variety of shapes according to practical demands such as square and round shapes. Different shapes and windings produce different induced current. Referring to FIG. 2 and FIG. 3, the sensor coil 121 can be a square sensor coil 1210 or a round sensor coil 1211. In one embodiment, the round sensor coil 1211 receives wireless energy.

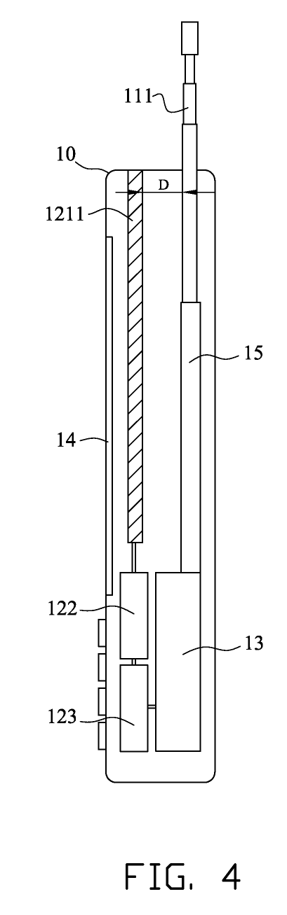

Referring to FIG. 4, a portable electronic device 10 as disclosed includes a charging apparatus 1, a display screen 14, and a printed circuit board 15. The antenna 11 in the charging apparatus 1 can be an external antenna or an internal antenna according to practical demands. In one embodiment, the antenna 11 is an external antenna 111 electrically connected to the printed circuit board. The electromagnetic field of the external antenna 111 focuses at the center of the round coil 1211 to enhance the efficiency of electromagnetic induction. The round coil 1211 and the external antenna 111 have a distance D which generates electromagnetic induction. The round coil 1211 transforms the wireless energy into an AC signal. The rectifier 122 is electrically connected to the round sensor coil 1211 and transforms the AC signal into a DC signal. The voltage of the DC signal is regulated by the voltage regulating filter 123 which is electrically connected to the rectifier 122, and output to the battery 13. When the voltage of the battery 13 is equal to the voltage of capacitor in the regulating filter 123, the charging procedure terminates preventing the battery from overcharging.

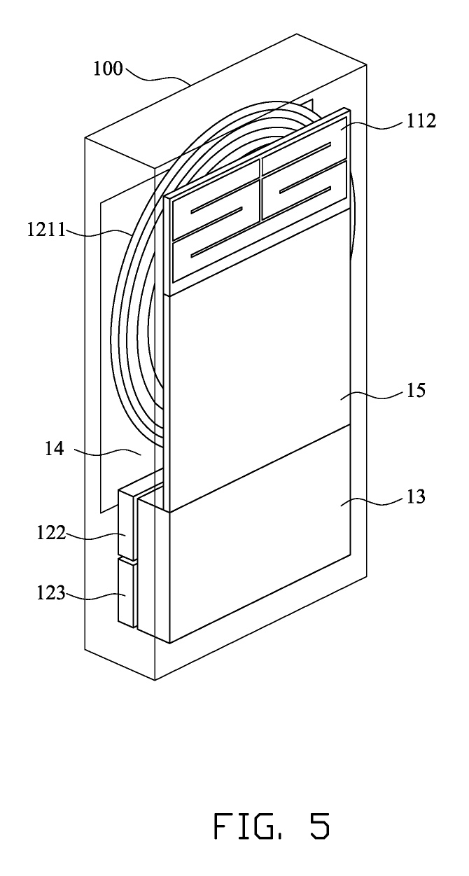

Referring to FIG. 5, a portable electronic device 100 is similar to the portable electronic device of FIG. 4, differing only in the use of an internal antenna 112. The round sensor coil 1211 is located between the display screen 14 and the hidden antenna 112 to produce an electromagnetic shielding effect, preventing user exposure thereto.

Compared with conventional rechargeable batteries requiring hardwiring or physical contact with electrodes, the charging apparatus as disclosed eliminates the need for physical contacts or electrodes, thereby avoiding wear on such elements normally associated with repeated recharging. Further, in the charging apparatus, the sensor coil receives the electromagnetic waves, negating potential safety hazards. As well, the wireless charging apparatus provides significantly enhanced user convenience.

Finally, it is to be understood that the embodiments described are intended to illustrate rather than limit the invention. Variations may be made to the embodiments without departing from the spirit of the invention as claimed. The embodiments illustrate the scope of the invention but do not restrict the scope of the invention.

What is claimed is:

1. A charging apparatus comprising:
an antenna;
a harvester to receive wireless energy from the antenna and convert the wireless energy into current; and
a battery connected to the harvester to receive the current from the harvester.

2. The charging apparatus as claimed in claim 1, wherein the harvester comprises
a sensor coil receiving and converting the wireless energy from the antenna to alternating current;
a rectifier electrically connected to the sensor coil to convert the alternating current to direct current; and
a voltage regulating filter electrically connected to the rectifier to regulate the voltage of the direct current and output the direct current to the battery.

3. The charging apparatus as claimed in claim 2, wherein the sensor coil is a square sensor coil.

4. The charging apparatus as claimed in claim 2, wherein the sensor coil is a round sensor coil.

5. The charging apparatus as claimed in claim 2, wherein the antenna and the sensor coil are separated.

6. The charging apparatus as claimed in claim 2, wherein the antenna and the sensor coil comprise the same material, having the same transmission and reception frequencies.

7. A charging method comprising:
using an antenna to receive wireless energy;
using a harvester to receive the wireless energy from the antenna and convert the wireless energy into current; and
causing a battery connected to the harvester to receive the current from the harvester.

8. The charging method as claimed in claim 7, wherein the step of using a harvester comprising providing a harvester including: a sensor coil receiving and converting the wireless energy from the antenna to alternating current; a rectifier electrically connected to the sensor coil to convert the alternating current to direct current; and a voltage regulating filter electrically connected to the rectifier to regulate the voltage of the direct current and then output the direct current to the battery.

9. The charging method as claimed in claim 8, further comprising making the antenna and the sensor coil comprise the same material, having the same transmission and reception frequency.

10. A portable electronic device comprising a printed circuit board and a charging apparatus, wherein the charging apparatus comprises: an antenna; a harvester to receive wireless energy from the antenna and convert the wireless energy into current; and a battery connected to the harvester to receive the current from the harvester.

11. The portable electronic devices as claimed in claim 10, wherein the harvester comprises: a sensor coil receiving and converting the wireless energy from the antenna to alternating current, a rectifier electrically connected to the sensor coil to convert the alternating current to direct current; and a voltage regulating filter electrically connected to the rectifier to regulate the voltage of the direct current and then output the direct current to the battery.

12. The portable electronic devices as claimed in claim 11, wherein the sensor coil is a square sensor coil.

13. The portable electronic devices as claimed in claim 11, wherein the sensor coil is a round sensor coil.

14. The portable electronic devices as claimed in claim 11, wherein the antenna and the sensor coil are separated.

15. The portable electronic devices as claimed in claim 11, wherein the antenna and the sensor coil comprise the same material, having the same transmission and reception frequencies.

16. The portable electronic devices as claimed in claim 11, wherein the antenna is an external antenna.

17. The portable electronic devices as claimed in claim 11, wherein the antenna is an internal antenna.
